(19) United States
(12) Patent Application Publication
(10) Pub. No.: US 2025/0137814 A1
(43) Pub. Date: May 1, 2025

(54) CASCADING MAP EDITS

(71) Applicant: TOYOTA JIDOSHA KABUSHIKI KAISHA, TOYOTA-SHI (JP)

(72) Inventors: MAUREEN K. ROWELL, Seattle, WA (US); GEORGE Y. OLIVER, Brooklyn, NY (US); ARIEL S. KADOURI, Brooklyn, NY (US); DAVID F. BOYLE, Brooklyn, NY (US)

(21) Appl. No.: 18/497,477

(22) Filed: Oct. 30, 2023

(51) Int. Cl. G01C 21/00; B60W 60/00

(52) U.S. Cl. CPC G01C 21/3859; B60W 60/001; G01C 21/3815; G01C 21/3878; B60W 2552/10; B60W 2555/60; B60W 2556/40

(57) ABSTRACT

Examples of the presently disclosed technology provide computerized systems and methods that automatically update digital maps in response to detected traffic sign updates in a rapid and efficient manner. Examples achieve these advantages by cascading traffic sign updates through multi-layered digital maps using specific methodologies tailored to different types of traffic sign updates. By providing rapid and accurate digital map updates, examples can improve performance for autonomous driving systems that rely on digital maps for determining vehicle navigation paths—thereby improving traffic safety and efficiency.

### TECHNICAL FIELD

The present disclosure relates generally to automotive systems and technologies, and more particularly, some examples relate to cascading edits for a digital map used in conjunction with autonomous vehicle (AV)/semi-autonomous vehicle (SAV) systems and vehicle navigation.

### DESCRIPTION OF RELATED ART

Autonomous vehicle (AV) and semi-autonomous vehicle (SAV) systems can control driving behaviors of a vehicle. Current AV and SAV systems can interpret sensory information, identify appropriate traffic configurations, determine vehicle navigation paths, and actuate vehicle systems in accordance with determined vehicle navigation paths. Many AV and SAV systems are directed systems that minimize vehicle collisions.

AV and SAV systems can leverage a digital map of a road network to determine vehicle navigation paths. In general, improved accuracy of a digital map can result in improved decision making for an AV/SAV system leveraging the digital map.

### BRIEF SUMMARY OF THE DISCLOSURE

According to various examples of the disclosed technology, a method for updating a digital map is provided. The method comprises: (a) responsive to detecting a speed limit sign update in a road network region, attributing, to path links of a digital map adjacent a speed limit sign representation, a speed limit value in accordance with the speed limit sign representation, wherein the attributions of step (a) reflect the detected speed limit sign update; and (b) propagating, in a direction of travel indicated by path links, the attributed speed limit values from step (a) to path links non-adjacent to speed limit sign representations, wherein the propagations of step (b) terminate at path links involving turn-related maneuvers. In certain examples, the method may further comprise: (c) attributing, to path links contained within carriageway links and without speed limit values attributed or propagated to them via steps (a)-(b), previously saved speed limit values for their associated carriageway links; and (d) propagating, in the direction of travel indicated by path links, the attributed and propagated speed limit values from steps (a)-(c) to the path links involving turn-related maneuvers. In some examples, the method can further comprise at least one of: (e) (1) updating speed limit values for carriageway links based on the speed limit values attributed and propagated to path links from steps (b)-(d); and (e) (2) using the updated digital map resulting from steps (a)-(d) as an input to an autonomous driving system. In various examples, each of the path links includes a function type, and the propagations of step (b) also terminate at transitions between path links of differing function types. In some examples, the digital map comprises: (i) speed limit sign representations representing speed limit signs of the road network region; (ii) carriageway links representing road segments of the road network region; (iii) junctions representing regions of intersection between road segments of the road network region; (iv) path links representing vehicular travel paths through lanes contained within the carriageway links and junctions. In certain of these examples, the digital map may comprise multiple layers. For example, the digital map may comprise: (1) a traffic sign layer comprising data related to traffic signs including the speed limit sign representations; (2) a carriageway link layer comprising the carriageway links; (3) a junction layer comprising the junctions; and (4) a path link layer comprising the path links.

In various examples, another method for updating a digital map is provided. The method, in accordance with examples of the technology disclosed herein comprises, responsive to detecting addition of a control sign representation on a junction side of a boundary between a carriageway link and a junction of the digital map: (a₁) drawing a control marking representation adjacent the control sign representation; (b₁) reapportioning, to the carriageway link, a region of the junction on a carriageway link-side of the control marking representation; (c₁) extending a path link contained within the carriageway link to the control marking representation; and (d₁) redrawing a path link contained within the junction based on location of the control marking representation. The method may further comprise, responsive to detecting addition of a second control sign representation within a threshold distance from the boundary between the carriageway link and the junction, on a carriageway link side of the boundary: (a₂) drawing a second control marking representation adjacent the second control sign representation; (b₂) reapportioning, to the junction, a region of the carriageway link on a junction-side of the second control marking representation; (c₂) shortening the path link contained within the carriageway link based on location of the second control marking representation; and (d₂) redrawing the path link contained within the junction based on location of the second control marking representation. In some examples, the method can further comprise, responsive to detecting addition of a third control sign representation adjacent the carriageway link and outside the threshold distance from a boundary between the carriageway link and any junction: (a₃) drawing a third control marking representation adjacent the third control sign representation; (b₃) splitting the carriageway link into a second carriageway link and a third carriageway link separated by the third control marking representation; and (c₃) splitting the path link contained within the carriageway link into a second path link and a third path link separated by the third control marking representation. As alluded to above, in certain examples the method can further comprise using the updated digital map as an input to an autonomous driving system. In some examples, the digital map may comprise (i) control sign representations representing control signs of the road network region; (2) carriageway links representing road segments of the road network region; (3) junctions representing regions of intersection between road segments of the road network region; and (4) path links representing vehicular travel paths through lanes contained within the carriageway links and junctions.

In some examples, a vehicle system is provided. The vehicle system, in accordance with examples of the technology disclosed herein comprises an electronic control unit (ECU) including machine executable instructions in non-transitory memory to perform a method comprising, responsive to detecting addition of a control sign representation within a threshold distance from a boundary between a carriageway link and a junction of a digital map, on a carriageway link side of the boundary: (a₁) drawing a control marking representation adjacent the control sign representation; (b₁) reapportioning, to the junction, a region of the carriageway link on a junction-side of the control marking representation; (c₁) shortening a path link contained within the carriageway link based on location of the control marking representation; and (d₁) redrawing a path link contained within the junction based on location of the control marking representation. In various examples, the method may further comprise: (a₂) drawing a second control marking representation adjacent the second control sign representation; (b₂) reapportioning, to the carriageway link, a region of the junction on a carriageway link-side of the second control marking representation; (c₂) extending the path link contained within the carriageway link to the second control marking representation; and (d₂) redrawing the path link contained within the junction based on location of the second control marking representation. In some examples, the method may further comprise: (a₃) drawing a third control marking representation adjacent the third control sign representation; (b₃) splitting the carriageway link into a second carriageway link and a third carriageway link separated by the third control marking representation; and (c₃) splitting the path link contained within the carriageway link into a second path link and a third path link separated by the third control marking representation. In certain examples, the vehicle may further comprise an autonomous driving system. In some of these examples, the method can further comprise using the updated digital map as an input to the autonomous driving system.

Other features and aspects of the disclosed technology will become apparent from the following detailed description, taken in conjunction with the accompanying drawings, which illustrate, by way of example, the features in accordance with examples of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various examples, is described in detail with reference to the following figures. The figures are provided for purposes of illustration only and merely depict examples.

FIG. 1 illustrates an example vehicle architecture for updating a digital map in response to a traffic sign update, in accordance with various examples of the presently disclosed technology.

FIGS. 2A-2F illustrate an example methodology for updating a digital map in response to a speed limit sign update, in accordance with various examples of the presently disclosed technology.

FIG. 3 illustrates an example methodology for updating a digital map in response to a control sign update, in accordance with various examples of the presently disclosed technology.

FIG. 4 illustrates an example methodology for updating a digital map in response to a control sign update, in accordance with various examples of the presently disclosed technology.

FIG. 5 illustrates an example methodology for updating a digital map in response to a control sign update, in accordance with various examples of the presently disclosed technology.

FIG. 6 is a flowchart illustrating example operations that can be performed to update a digital map in response to a speed limit sign update, in accordance with various examples of the presently disclosed technology.

FIGS. 7A-7C are flowcharts illustrating example operations that can be performed to update a digital map in response to a control sign update, in accordance with various examples of the presently disclosed technology.

FIG. 8 is an example computing component that may be used to implement various features of examples described in the present disclosure.

The figures are not exhaustive and do not limit the present disclosure to the precise form disclosed.

### DETAILED DESCRIPTION

As alluded to above, AV and SAV systems can leverage a digital map of a road network to determine vehicle navigation paths. In general, improved accuracy of a digital map can result in improved decision making for an AV/SAV system leveraging the digital map-which can lead to improved traffic safety and efficiency. Accordingly, there is an important need for maintaining accurate digital maps of road networks utilized by AV/SAV systems. However, such a pursuit presents certain challenges.

For example, many digital maps rely on contextual information conveyed by physical traffic signs (e.g., speed limit signs, stop signs, yield signs, etc.) of a road network. For instance, a digital map may rely on speed limit signs to impose “digital” speed limits on representations of road segments in the digital map. An AV/SAV leveraging the digital map can control a vehicle consistent with the “digital” speed limits imposed on the digital map. A digital map can also rely on the locations of stop and yield signs to draw “digital” control markings that dictate where—in relation to a physical road segment and/or intersection—an AV/SAV controls a vehicle to stop, slow down, commence a turn-related maneuver (e.g., a left or right turn, a U-turn, etc.), etc.

While traffic signs can provide important contextual information for digital maps leveraged by AV/SAV systems, the frequency with which traffic signs are updated (e.g., added, removed, moved, modified with different content, etc.) can make it difficult to keep digital maps up to date. For example, while new traffic sign locations and/or new contextual information conveyed by traffic signs can be detected by various connected entities (e.g., by cameras or related sensors of connected vehicles navigating road regions proximate to the traffic sign updates), updating an expansive digital map in real-time (or close to real-time) in response to the detected traffic sign updates is still a serious challenge. Without specific rules/algorithms designed to dynamically adjust a digital map in response to traffic sign updates in a road network, conventional digital map technologies frequently rely on manual/human engineer-driven updates to account for these changes. Unfortunately, given the frequency of traffic sign updates that can occur in a road network, these manual/human engineer-driven updates often fail to keep pace with current road network states—resulting in digital map inaccuracies. As alluded to above, digital map inaccuracies can lead to reduced performance for AV/SAV systems that rely on digital maps for determining vehicle navigation paths, potentially leading to reduced traffic safety and efficiency.

Against this backdrop, examples of the presently disclosed technology provide computerized systems and methods that automatically update digital maps in response to detected traffic sign updates in a rapid and efficient manner. As described in greater detail below, examples achieve these advantages by cascading traffic sign updates through multi-layered digital maps using specific methodologies tailored to different types of traffic sign updates.

For example, a digital map consistent with the presently disclosed technology can leverage multiple logical/hierarchical layers amenable to the rapid updates disclosed herein. The layers of the digital map may comprise: (1) a traffic sign layer comprising data related to traffic signs (e.g., data related to speed limit signs, data related to control signs such as stop signs and yield signs, etc.); (2) a carriageway link layer comprising carriageway links that represent road segments of a road network region; (3) a junction layer comprising junctions that represent regions of intersection between road segments of the road network; and (4) a path link layer comprising path links that represent (desired/optimal) vehicular travel paths through lanes contained within the carriageway links and junctions. AV/SAV systems can leverage the path links of the digital map to determine and effectuate navigation paths for a vehicle.

As alluded to above, examples can automatically update the multi-layered map described above in a rapid and efficient manner by cascading traffic sign updates through the multiple map layers using specific methodologies tailored to different types of traffic sign updates.

For instance, responsive to detecting a speed limit sign update in a road network region, examples can (as a first step) attribute, to each path link adjacent a speed limit sign representation, a speed limit value in accordance with the speed limit sign representation. Here, the speed limit sign representations may represent the content and locations of speed limit signs of the road network region. The attributions of this first step will reflect the detected speed limit sign update. Examples can next (as a second step) propagate, in a direction of travel indicated by the path links, the attributed speed limit values from the first step to path links non-adjacent to speed limit sign representations. Here, to properly reflect jurisdictional speed limit rules, examples can terminate the propagations of the second step at path links involving turn-related maneuvers (e.g., where a vehicle would turn onto a second street from a first street having a potentially different speed limit). In some examples, each of the path links of the multi-layered map may include a function type, and the propagations of the second step may also terminate at transitions between path links of differing function types. Such a feature may account for typical changes in speed limits associated with transitioning from different road segment types (e.g., transitioning from a highway to a highway exit ramp). In various examples, the above-described “speed limit sign update” methodology may further comprise a third step that involves attributing, to path links contained within carriageway links and without speed limit values attributed or propagated to them via the first and second steps, previously saved speed limit values for their associated carriageway links. The speed limit sign update methodology may then further comprise a fourth step that involves propagating, in the direction of travel indicated by path links, the attributed and propagated speed limit values from steps one-three to the path links involving turn-related maneuvers. In some examples, this speed limit sign update methodology may further comprise updating speed limit values for carriageway links based on the speed limit values attributed and propagated to path links from steps one-four. In certain examples, the speed limit sign update methodology may further comprise using the digital map resulting from steps one-four as an input to an autonomous driving system.

Examples of the presently disclosed technology also include tailored methodologies for updating the multi-layered digital map in response to “control sign” updates (as used herein a control sign may refer to a stop sign, yield sign, or an analogous non-speed limit traffic sign that that imposes jurisdictional limits on vehicle movement within a road network). As alluded to above, these control sign updates may be detected by various connected entities (e.g., by cameras or related sensors of connected vehicles navigating the road network region).

The methodology for updating a digital map in response to control sign updates (i.e., “the control sign update methodology”) may be adapted to different physical/real-world scenarios. For instance, a first example physical/real-world scenario may involve movement/addition of a control sign closer to an intersection at a transition between a road segment and the intersection. As described in greater detail below, when the newly moved/added control sign is represented in a digital map, this scenario may correspond with detecting addition of a control sign representation on a junction side of a boundary between a carriageway link and a junction of the digital map. A second example physical/real-world scenario may involve movement/addition of a control sign further from an intersection at a transition between a road segment and the intersection. As described in greater detail below, when the newly moved/added control sign is represented in a digital map, this scenario may correspond with detecting addition of a control sign representation within a threshold distance from a boundary between a carriageway link and a junction of the digital map, on a carriageway link side of the boundary. A third example physical/real-world scenario may involve addition of a control sign at a region of a road segment that is not at (or proximate to) a transition between the road segment and an intersection. As described in greater detail below, when the newly moved/added control sign is represented in a digital map, this scenario may correspond with detecting addition of a control sign representation adjacent a carriageway link and outside a threshold distance from a boundary between the carriageway link and any junction of the digital map. Leveraging these tailored approaches for specific physical/real-world scenarios, the presently disclosed “control sign update” methodology can more accurately reflect/inform desired driving behavior.

Before describing examples of the presently disclosed technology in more detail, it should be understood that the systems and methods disclosed herein may be implemented with any of a number of different vehicles and vehicle types. For example, the systems and methods disclosed herein may be used with automobiles, trucks, motorcycles, recreational vehicles and other like on or off-road vehicles. In addition, the principals disclosed herein may also extend to hybrid vehicles, gasoline- or diesel-powered vehicles, fuel-cell vehicles, electric vehicles, or other vehicles.

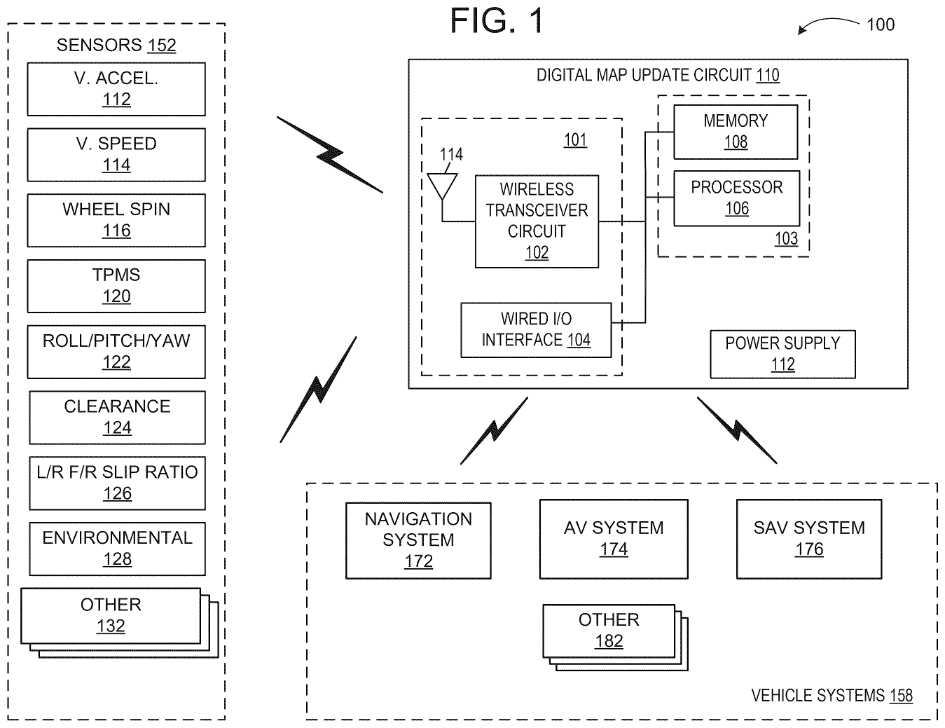

FIG. 1 illustrates an example vehicle architecture for updating a digital map in response to a traffic sign update, in accordance with various examples of the presently disclosed technology.

Referring now to FIG. 1, vehicle architecture 100 includes digital map update circuit 110, a plurality of sensors 152, and a plurality of vehicle systems 158. Sensors 152 and vehicle systems 158 can communicate with digital map update circuit 110 via a wired or wireless communication interface. Although sensors 152 and vehicle systems 158 are depicted as communicating with digital map update circuit 110, they can also communicate with each other as well as with other vehicle systems. Digital map update circuit 110 can be implemented as an electronic control unit (ECU) or as part of an ECU. In other examples, digital map update circuit 110 can be implemented independently of an ECU.

Digital map update circuit 110 in this example includes a communication circuit 101, a decision circuit 103 (including a processor 106 and memory 108 in this example) and a power supply 112. Components of digital map update circuit 110 are illustrated as communicating with each other via a data bus, although other communication interfaces can be included.

Processor 106 can include a GPU, CPU, microprocessor, or any other suitable processing system. The memory 108 may include one or more various forms of memory or data storage (e.g., flash, RAM, etc.) that may be used to store digital maps, historical digital map updates, speed limit values associated with carriageway links, default jurisdictional speed limit values, calibration parameters, images (analysis or historic), point parameters, instructions and variables for processor 106 as well as any other suitable information. Memory 108 can be made up of one or more modules of one or more different types of memory, and may be configured to store data and other information as well as operational instructions that may be used by the processor 106 to implement digital map updates.

Although the example of FIG. 1 is illustrated using processor and memory circuitry, as described below with reference to circuits disclosed herein, decision circuit 103 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up digital map update circuit 110.

Communication circuit 101 may include either or both a wireless transceiver circuit 102 with an associated antenna 114 and a wired I/O interface 104 with an associated hardwired data port (not illustrated). As this example illustrates, communications with digital map update circuit 110 can include either or both wired and wireless communications circuits 101. Wireless transceiver circuit 102 can include a transmitter and a receiver (not shown) to allow wireless communications via any of a number of communication protocols such as, for example, Wifi, Bluetooth, near field communications (NFC), Zigbee, and any of a number of other wireless communication protocols whether standardized, proprietary, open, point-to-point, networked or otherwise. Antenna 114 is coupled to wireless transceiver circuit 102 and is used by wireless transceiver circuit 102 to transmit radio signals wirelessly to wireless equipment with which it is connected and to receive radio signals as well. These RF signals can include information of almost any sort that is sent or received by digital map update circuit 110 to/from other entities such as sensors 152 and vehicle systems 158.

Wired I/O interface 104 can include a transmitter and a receiver (not shown) for hardwired communications with other devices. For example, wired I/O interface 104 can provide a hardwired interface to other components, including sensors 152 and vehicle systems 158. Wired I/O interface 104 can communicate with other devices using Ethernet or any of a number of other wired communication protocols whether standardized, proprietary, open, point-to-point, networked or otherwise.

Power supply 112 can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include vehicle acceleration sensors 112, vehicle speed sensors 114, wheelspin sensors 116 (e.g., one for each wheel), a tire pressure monitoring system (TPMS) 120, accelerometers such as a 3-axis accelerometer 122 to detect roll, pitch and yaw of the vehicle, vehicle clearance sensors 124, left-right and front-rear slip ratio sensors 126, and environmental sensors 128 (e.g., to detect salinity or other environmental conditions). Additional sensors 132 can also be included as may be appropriate for a given implementation of digital map update circuit 110. For example, additional sensors 132 may include sensors for detecting traffic sign updates in a road network (e.g., cameras, proximity sensors such as radar and LiDAR sensors, etc.) There may also be additional sensors for detecting and/or computing other operational parameters of vehicle architecture 100.

Vehicle systems 158 can include any of a number of different vehicle components or subsystems used to control or monitor various aspects of the vehicle and its performance. In this example, the vehicle systems 158 include a navigation system 172, an autonomous vehicle (AV) system 174, a semi-autonomous vehicle (SAV) system 176, and other vehicle systems 182 (e.g., vehicle systems or sub-systems that AV system 174 and/or SAV system 176 can use to actuate control of the vehicle).

AV and SAV systems (e.g., AV system 174 and SAV system 176) can control driving behaviors of the vehicle. Current AV and SAV systems can interpret sensory information, identify appropriate traffic configurations, determine vehicle navigation paths, and actuate vehicle systems in accordance with determined vehicle navigation paths. Many AV and SAV systems are directed systems that minimize vehicle collisions.

As alluded to above, AV and SAV systems (e.g., AV system 174 and SAV system 176) can leverage a digital map of a road network to determine vehicle navigation paths. In general, improved accuracy of a digital map can result in improved decision making for an AV/SAV system leveraging the digital map. Accordingly, AV system 174 and SAV system 176 can leverage rapid and accurate digital map updates generated by digital map update circuit 110 for improved autonomous/semi-autonomous driving performance. Relatedly, navigation system 172 can also leverage the rapid and accurate digital map updates generated by digital map update circuit 110 for improved navigation displays.

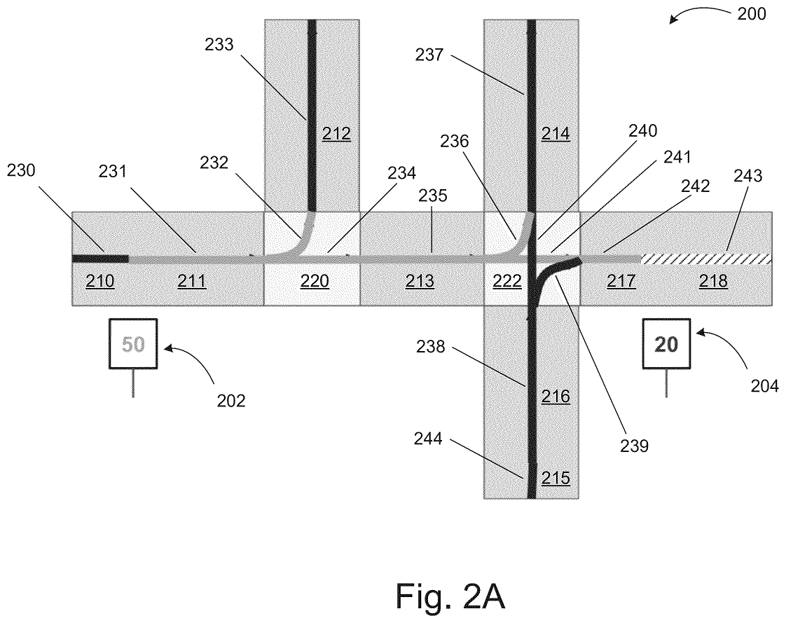

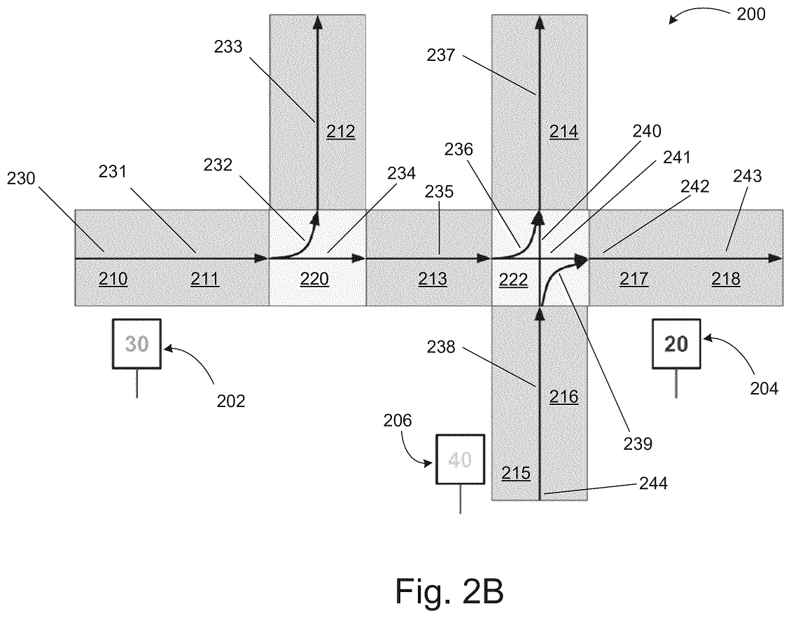

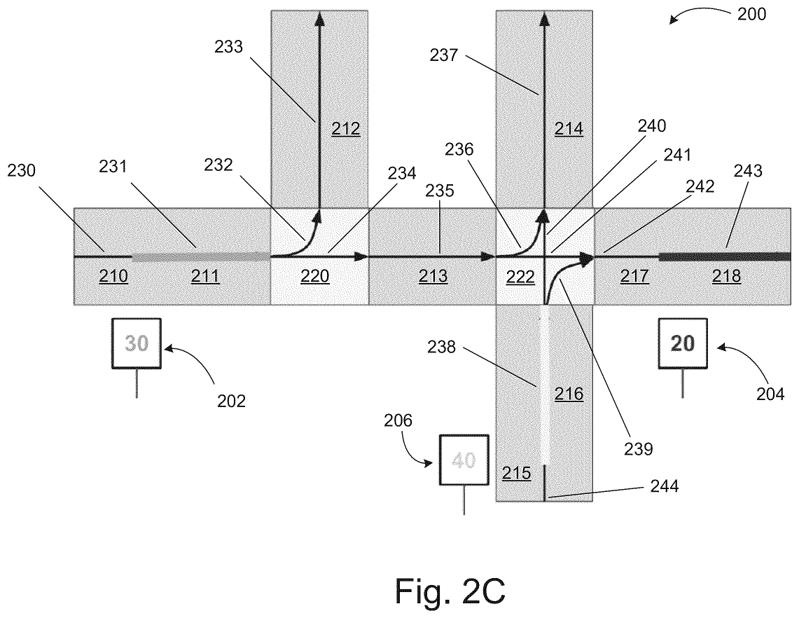

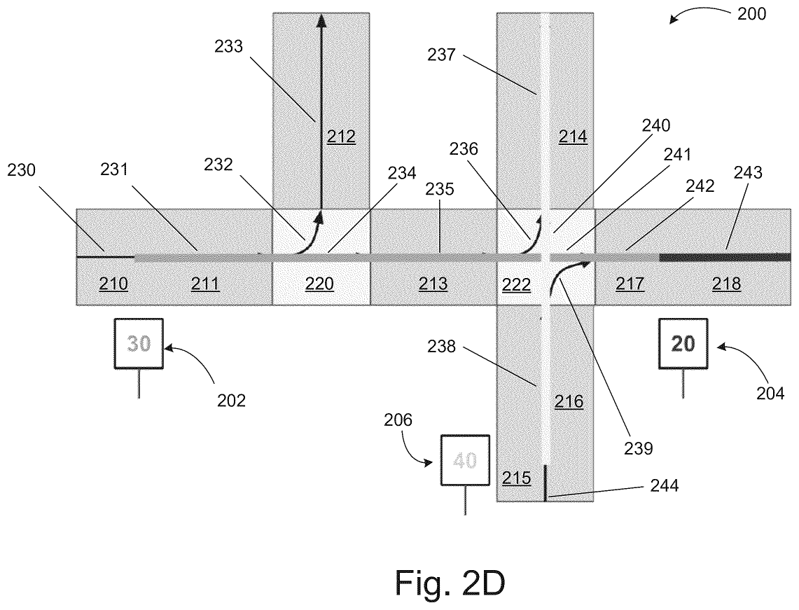

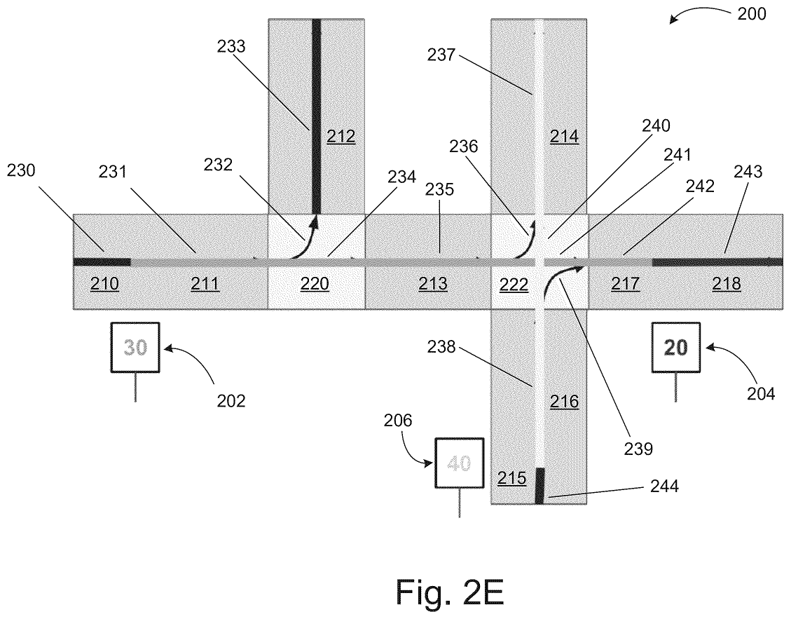

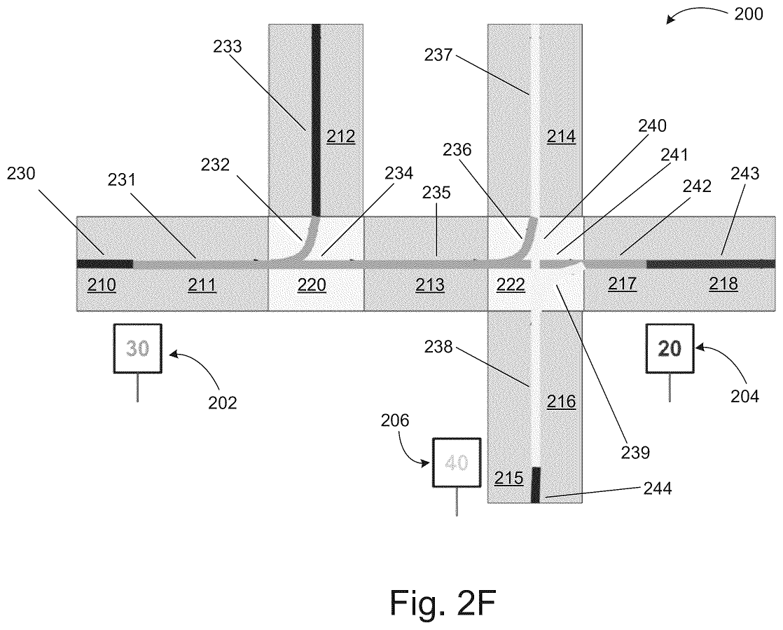

FIGS. 2A-2F illustrate an example methodology for updating a digital map in response to a speed limit sign update, in accordance with various examples of the presently disclosed technology.

Namely, FIGS. 2A-2F depict a portion of a digital map 200 of a road network region. As alluded to above, digital map 200 may comprise multiple logical/hierarchical layers amenable to the rapid updates disclosed herein. For example, digital map 200 may include: (1) a traffic sign layer comprising data related to traffic signs in the road network region (e.g., speed limit sign representations 202 and 204); (2) a carriageway link layer comprising carriageway links that represent road segments of the road network region (e.g., carriageway links 210-218); (3) a junction layer comprising junctions that represent regions of intersection between road segments of the road network region (e.g., junctions 220 and 222); and (4) a path link layer comprising path links that represent (desired/optimal) vehicular travel paths through lanes contained within the carriageway links and junctions (e.g., path links 230-244). As alluded to above, AV/SAV systems can leverage the path links of digital map 200 to determine and effectuate navigation paths for a vehicle.

FIG. 2A illustrates an example “pre-update state” for digital map 200. As depicted, each of the path links of digital map 200 includes an attributed speed limit value in the pre-update state (represented by thicker lines overlaying the path links in FIG. 2A). For example, path links 231, 232, 234, 235, 236, 241, and 242 have an attributed speed limit value of 50 miles per hour (mph) consistent with the speed limit conveyed by speed limit sign representation 202 (in FIG. 2A the 50 mph speed limit value is represented by thick overlaying lines having a relatively lighter gray shading). Relatedly, path link 243 has an attributed speed limit value of 20 mph consistent with the speed limit conveyed by speed limit sign representation 204 (in FIG. 2A the 20 mph speed limit value is represented by the thick overlaying line having a black and white-striped shading). Path links 230, 233, 237, 238, 239, and 244 have a third speed limit value (e.g., 25 mph) attributed to them (in FIG. 2A the 25 mph speed limit value is represented by thick overlaying lines having a relatively darker gray shading). The third speed limit value may be associated with speed limit sign(s)/speed limit sign representation(s) not depicted in FIG. 2A, or with default jurisdictional speed limits for the road network region.

As depicted in FIG. 2B, a new speed limit sign may be added to the road network region. This new speed limit sign is represented by speed limit sign representation 206 in digital map 200. Relatedly, an existing speed limit sign may be updated. For example, the speed limit sign represented by speed limit sign representation 202 may be updated to convey a new speed limit value of 30 mph. As alluded to above, these speed limit sign updates may be detected by various connected entities (e.g., by cameras or related sensors of connected vehicles navigating the road network region).

In various examples, a first step in the methodology for updating digital map 200 in response to the detected speed limit sign update(s) (i.e., “the speed limit sign update methodology”) may involve clearing/removing the speed limit values attributed to the path links of digital map 200 (such removal is depicted in FIG. 2B through the removal of the thick lines overlaying the path links seen in FIG. 2A). This mass/complete removal can facilitate a more efficient update. The mass/complete removal approach can also better facilitate updates involving multiple speed limit signs (e.g., updates where multiple speed limit signs are added, removed, moved, or updated in the road network region).

Before describing FIG. 2C, it was worth noting that each path link of digital map 200 includes a direction of travel (indicated by the arrows), which can be better seen in FIG. 2B with the attributed speed limit values (i.e., the thicker lines overlaying the path links) cleared/removed.

FIG. 2C depicts a second step in the example speed limit sign update methodology—namely attributing to each path link of digital map 200 adjacent a speed limit sign representation, a speed limit value in accordance with the speed limit sign representation(s). Here, the attributions of the second step of the speed limit sign update methodology will reflect the detected speed limit sign update(s). For example, a speed limit value of 40 mph is attributed to path link 238 (represented by the thick overlaying line having the lightest gray shading)—consistent with the speed limit value conveyed by speed limit sign representation 206 (which itself represents a newly added, physical speed limit sign of the road network region). Likewise, a speed limit value of 30 mph is attributed to path link 231 (represented by the thick overlaying line having the medium gray shading)—consistent with the new speed limit value conveyed by speed limit sign representation 202 (which itself represents a newly updated, physical speed limit sign of the road network region). Similarly, a speed limit value of 20 mph is attributed to path link 243 (represented by the thick overlaying line having the dark gray shading)—consistent with the speed limit value conveyed by speed limit sign representation 204.

FIG. 2D depicts a third step in the example speed limit sign update methodology—namely propagating, in a direction of travel indicated by path links, the attributed speed limit values from the second step in the speed limit sign update methodology to path links non-adjacent to speed limit sign representations. As depicted, to reflect jurisdictional speed limit rules, the propagations of this third step may terminate at path links involving turn-related maneuvers (e.g., where a vehicle would turn onto a second street from a first street having a potentially different speed limit). For example, such propagations may terminate at path links 232, 236, and 239 which involve turn-related maneuvers (e.g., left turns, right turns, U-turns, etc.) in junctions 220 and 222. While not depicted in the specific example of FIG. 2D, path links may include a function type. In these examples, the propagations of the third step in the speed limit sign update methodology may also terminate at transitions between path links of differing function types. Such a feature may account for typical changes in speed limits associated with transitioning from different road segment types (e.g., transitioning from a highway to a highway exit ramp).

FIG. 2E depicts a fourth step in the example speed limit sign update methodology—namely attributing to path links contained within carriageway links and without speed limit values attributed or propagated to them via steps two and three, previously saved speed limit values for their associated carriageway links. For example, a previously save speed limit value for carriageway link 215 may be attributed to path link 244. Likewise, previously saved speed limit values for carriageway links 210 and 212 may be attributed to path links 230 and 233 respectively.

FIG. 2F depicts a fifth step in the example speed limit sign update methodology-namely propagating, in the direction of travel indicated by path links, the attributed and propagated speed limit values from steps two-four to the path links of digital map 200 involving turn-related maneuvers (i.e., path links 232, 236, and 239).

While not depicted, the example speed limit sign update methodology may further comprise updating speed limit values for carriageway links based on the speed limit values attributed and propagated to path links from steps two-five of the speed limit sign update methodology. The speed limit sign update methodology may also further comprise using updated digital map 200 as an input to an autonomous driving system (e.g., an AV and/or SAV system).

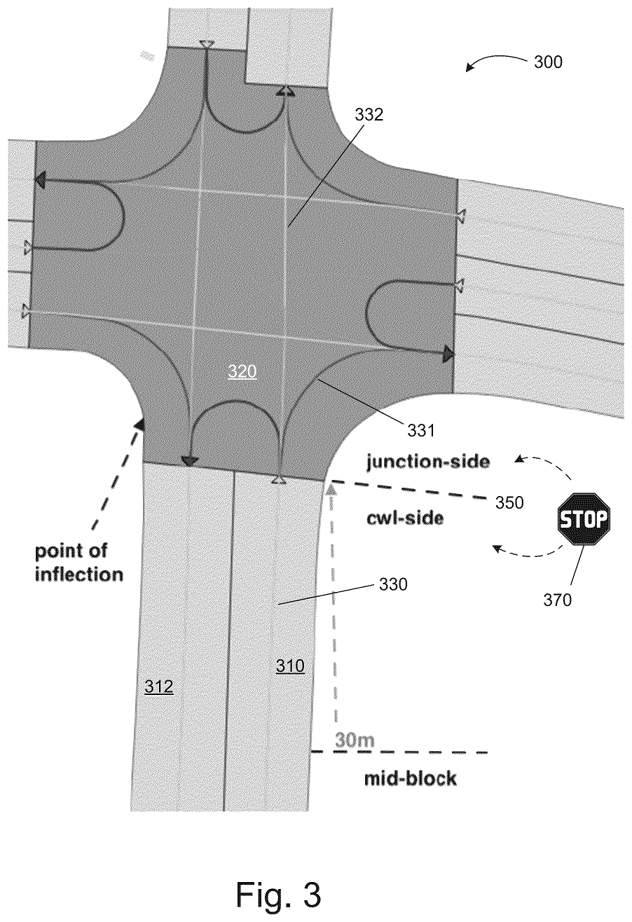

FIG. 3 illustrates an example methodology for updating a digital map in response to a control sign update, in accordance with various examples of the presently disclosed technology.

Namely, FIG. 3 depicts a portion of a digital map 300 of a road network region. Like digital map 200, digital map 300 may comprise multiple logical/hierarchical layers amenable to the rapid updates disclosed herein. For example, digital map 300 may include: (1) a traffic sign layer comprising data related to traffic signs in the road network region (e.g., control sign representation 370); (2) a carriageway link layer comprising carriageway links that represent road segments of the road network region (e.g., carriageway links 310 and 312); (3) a junction layer comprising junctions that represent regions of intersection between road segments of the road network region (e.g., junction 320); and (4) a path link layer comprising path links that represent (desired/optimal) vehicular travel paths through lanes contained within the carriageway links and junctions (e.g., path links 330-332). AV/SAV systems can leverage the path links of digital map 300 to determine and effectuate navigation paths for a vehicle.

As alluded to above, examples of the presently disclosed technology include tailored methodologies for updating digital map 300 in response to detected “control sign” updates (as used herein a control sign may refer to a stop sign, yield sign, or an analogous non-speed limit traffic sign that imposes jurisdictional limits on vehicle movement within a road network). As alluded to above, these control sign updates may be detected by various connected entities (e.g., by cameras or related sensors of connected vehicles navigating the road network region).

The methodology for updating digital map 300 in response to control sign updates (i.e., “the control sign update methodology”) may be adapted to different physical/real-world scenarios. For instance, a first example physical/real-world scenario may involve movement/addition of a control sign closer to an intersection at a transition between a road segment and the intersection. When the newly moved/added control sign is represented in digital map 300, this scenario may correspond with detecting addition of a control sign representation on a junction side of a boundary between a carriageway link and a junction of digital map 300. A second example physical/real-world scenario may involve movement/addition of a control sign further from an intersection at a transition between a road segment and the intersection. When the newly moved/added control sign is represented in digital map 300, this scenario may correspond with detecting addition of a control sign representation within a threshold distance from a boundary between a carriageway link and a junction of digital map 300, on a carriageway link side of the boundary. A third example physical/real-world scenario may involve addition of a control sign at a region of a road segment that is not at (or proximate to) a transition between the road segment and an intersection. When the newly moved/added control sign is represented in digital map 300, this scenario may correspond with detecting addition of a control sign representation adjacent a carriageway link and outside a threshold distance from a boundary between the carriageway link and any junction of the digital map. Leveraging these tailored approaches for specific physical/real-world scenarios, the presently disclosed “control sign update” methodology can more accurately reflect/inform desired driving behavior.

FIG. 3 can help illustrate the first and second example physical/real-world scenarios from the previous paragraph.

For instance, responsive to detecting addition/movement of a control sign at a transition between a road segment and an intersection, examples can generate control sign representation 370 in digital map 300 representing the newly added/moved control sign. Then, responsive to detecting addition of control sign representation 370 on a junction side of boundary 350 between carriageway link 310 (representing the road segment) and junction 320 (representing the intersection), examples can draw a control marking representation (not depicted) adjacent control sign representation 370. The control marking representation may be drawn parallel to carriageway link 310's face in order to reflect how control markings are typically drawn on road segments. Examples can next reapportion, to carriageway link 310, a region of junction 320 on a carriageway link-side of the control marking representation. After this reapportionment, examples can extend path link 330 contained within carriageway link 310 to the control marking representation. Examples can also redraw path link 331 and/or path link 332 contained within junction 320 based on location of the control marking representation. Here, the extended/redrawn path links can be leveraged by an AV/SAV system to more appropriately navigate the road segment and intersection represented by carriageway link 310 and junction 320 respectively.

Relatedly, responsive to detecting addition of control sign representation 370 on a junction side of boundary 350 and within a threshold distance of boundary 350, examples can draw a (second) control marking representation adjacent control sign representation 370. Again, the (second) control marking representation may be drawn parallel to carriageway link 310's face in order to reflect how control markings are typically drawn on road segments. Examples can next reapportion, to junction 320, a region of carriageway link 310 on a junction-side of the (second) control marking representation. After such reapportionment, examples can shorten path link 330 contained within carriageway link 310 based on location of the (second) control marking representation. Examples can also redraw path link 331 and/or path link 332 contained within junction 320 based on location of the (second) control marking representation. Here again, the shortened/redrawn path links can be leveraged by an AV/SAV system to more appropriately navigate the road segment and intersection represented by carriageway link 310 and junction 320 respectively.

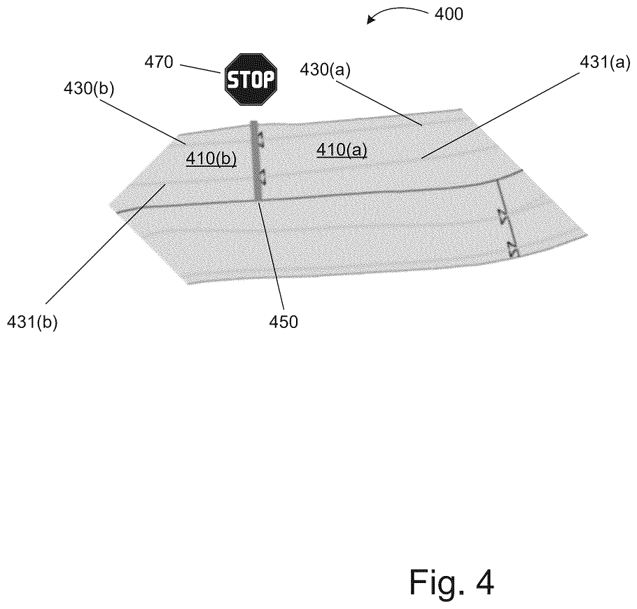

FIG. 4 also illustrates an example methodology for updating a digital map in response to a control sign update, in accordance with various examples of the presently disclosed technology.

Namely, FIG. 4 depicts a portion of a digital map 400 of a road network region. Like digital maps 200 and 300, digital map 400 may comprise multiple logical/hierarchical layers amenable to the rapid updates disclosed herein. For example, digital map 400 may include: (1) a traffic sign layer comprising data related to traffic signs in the road network region (e.g., control sign representation 470); (2) a carriageway link layer comprising carriageway links that represent road segments of the road network region (e.g., a carriageway link 410 in a pre-update state of digital map 400; and carriageway links 410(a)-(b) in a post-update state of digital map 400); (3) a junction layer comprising junctions that represent regions of intersection between road segments of the road network region (not depicted in FIG. 4); and (4) a path link layer comprising path links that represent (desired/optimal) vehicular travel paths through lanes contained within the carriageway links and junctions (e.g., path links 430 and 431 in a pre-update state of digital map 400; and path links 430(a)-(b) and 431(a)-(b) in a post-update state of digital map 400). As alluded to above, AV/SAV systems can leverage the path links of digital map 400 to determine and effectuate navigation paths for a vehicle.

FIG. 4 depicts an example scenario involving addition/movement of a control sign (represented by control sign representation 470) at a mid-region of a road segment that is not at (or proximate to) a transition between the road segment and an intersection.

Accordingly, responsive to detecting addition/movement of a control sign at the mid-region of the road segment, examples can generate control sign representation 470 representing the newly added/moved control sign. Then, responsive to detecting addition of control sign representation 470 adjacent a carriageway link 410 (representing the road segment in a pre-update state of digital map 400) and outside a threshold distance from a (potential) boundary between carriageway link 410 and a junction of digital map 400 (in this case, carriageway link 410 does not abut a junction and thus the control sign representation addition is outside the threshold distance by default), examples can draw a control marking representation 450. As alluded to above, control marking representation 450 may be drawn parallel to carriageway link 410's face. Next, examples can split carriageway link 410 into carriageway link 410(a) and carriageway link 410(b). As depicted, carriageway link 410(a) and carriageway link 410(b) may be separated by control marking representation 450. Examples can also split path links 430 and 431 (from a pre-update state of digital map 400) into path links 430(a)/430(b) and 431(a)/431(b) respectively. New/split path links 430(a) and 430(b) may be separated by control marking representation 450. New/split path links 431(a) and 431(b) may also be separated by control marking representation 450. Again, the split/redrawn path links and control marking representation 450 can be leveraged by an AV/SAV system to more appropriately navigate the road segment represented by carriageway links 410(a) and 410(b) respectively.

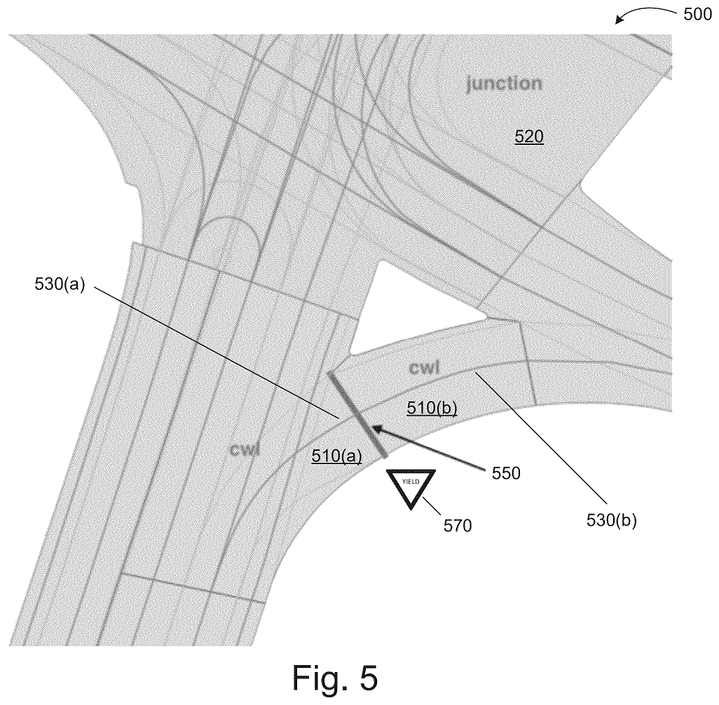

FIG. 5 also illustrates an example methodology for updating a digital map in response to a control sign update, in accordance with various examples of the presently disclosed technology.

Namely, FIG. 5 depicts a portion of a digital map 500 of a road network region. Like digital maps 200-400, digital map 500 may comprise multiple logical/hierarchical layers amenable to the rapid updates disclosed herein. For example, digital map 500 may include: (1) a traffic sign layer comprising data related to traffic signs in the road network region (e.g., control sign representation 570); (2) a carriageway link layer comprising carriageway links that represent road segments of the road network region (e.g., a carriageway link 510 in a pre-update state of digital map 500; and carriageway links 510(a)-(b) in a post-update state of digital map 500); (3) a junction layer comprising junctions that represent regions of intersection between road segments of the road network region (e.g., junction 520); and (4) a path link layer comprising path links that represent (desired/optimal) vehicular travel paths through lanes contained within the carriageway links and junctions (e.g., path link 530 in a pre-update state of digital map 500; and path links 530(a)-(b) in a post-update state of digital map 500). As alluded to above, AV/SAV systems can leverage the path links of digital map 500 to determine and effectuate navigation paths for a vehicle.

FIG. 5 depicts an example scenario involving addition/movement of a control sign (represented by control sign representation 570) at a region of a road segment that is not at (or proximate to) a transition between the road segment and an intersection. Namely, FIG. 5 depicts a representation of a “slip lane” (sometimes referred to as a “filter lane”). The slip lane may refer to a road segment that allows vehicles to change roads without entering an intersection.

Accordingly, responsive to detecting addition/movement of a control sign at the region of the road segment that is not at (or proximate to) a transition between the road segment and an intersection (e.g., proximate to a slip lane), examples can generate control sign representation 570 representing the newly added/moved control sign. Then, responsive to detecting addition of control sign representation 570 adjacent a carriageway link 510 (representing the road segment in a pre-update state of digital map 500) and outside a threshold distance from any (potential) boundary between carriageway link 510 and a junction of digital map 500 (in this specific example, carriageway link 510 does not abut a junction and thus the control sign representation addition is not within the threshold distance by default), examples can draw a control marking representation 550. Next, examples can split carriageway link 510 into carriageway link 510(a) and carriageway link 510(b). As depicted, carriageway link 510(a) and carriageway link 510(b) may be separated by control marking representation 550. Examples can also split path link 530 (from a pre-update state of digital map 500) into path links 530(a) and 530(b). New/split path links 530(a) and 530(b) may be separated by control marking representation 550. Again, the split/redrawn path links and control marking representation 550 can be leveraged by an AV/SAV system to more appropriately navigate the road segment represented by carriageway links 510(a) and 510(b) respectively.

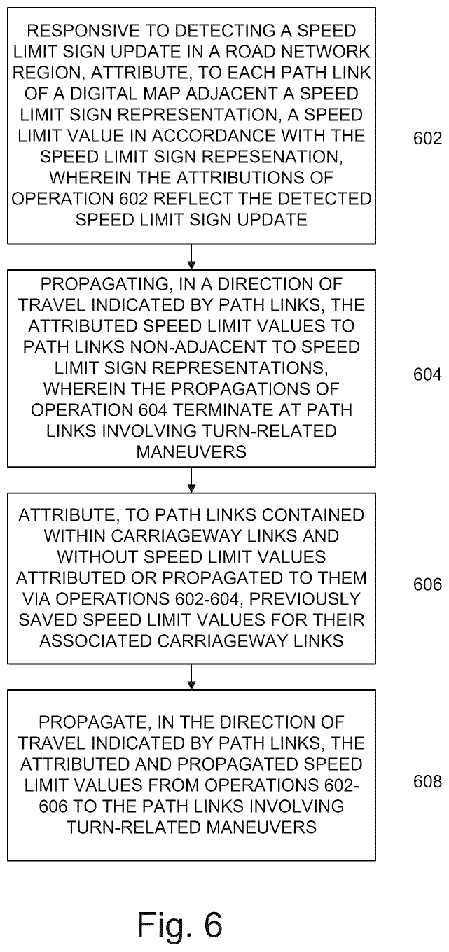

FIG. 6 is a flowchart illustrating example operations that can be performed to update a digital map in response to a speed limit sign update, in accordance with various examples of the presently disclosed technology. In various examples the operations of FIG. 6 may be performed by digital map update circuit 110 of FIG. 1

As depicted, responsive to detecting a speed limit sign update in a road network region, examples can perform operation 602 to attribute, to each path link of a digital map adjacent a speed limit sign representation, a speed limit value in accordance with the speed limit sign representation. Here, the attributions of operation 602 may reflect the detected speed limit sign update.

As alluded to above, the digital map may comprise: (1) speed limit sign representations representing speed limit signs of the road network region; (2) carriageway links representing road segments of the road network region (in certain examples the carriageway links may represent polygons that enclose road segments of the road network region having a constant number of lanes); (3) junctions representing regions of intersection between road segments of the road network region; and (4) path links representing (desired/optimal) vehicular travel paths through lanes contained within the carriageway links and junctions. In various examples, the digital map may be a multi-layered digital map comprising: (a) a traffic sign layer comprising data related to traffic signs including the speed limit sign representations; (b) a carriageway link layer comprising the carriageway links; (c) a junction layer comprising the junctions; and (d) a path link layer comprising the path links. As alluded to above, these multiple logical/hierarchical layers of the digital map are especially amenable to the rapid updates disclosed herein.

As depicted, examples can perform operation 604 to propagate, in a direction of travel indicated by path links, the attributed speed limit values from operation 602 to path links non-adjacent to speed limit sign representations. The propagations of operation 604 may terminate at path links involving turn-related maneuvers (e.g., left turns, right turns, U-turns, etc.). As alluded to above, in certain examples the path links of the digital map may include a function type. In these examples, the propagations of operation 604 may also terminate at transitions between path links of differing function types. Such a feature may account for typical changes in speed limits associated with transitioning from different road segment types (e.g., transitioning from a highway to a highway exit ramp).

Examples can perform operation 606 to attribute, to path links contained within carriageway links and without speed limit values attributed or propagated to them via operations 602-604, previously saved speed limit values for their associated carriageway links.

Examples can then perform operation 608 to propagate, in the direction of travel indicated by path links, the attributed and propagated speed limit values from operations 602-606 to the path links involving turn-related maneuvers.

As alluded to above, examples may perform further operations. For instance, examples may perform an operation (not depicted) to update speed limit values for carriageway links based on the speed limit values attributed and propagated to path links from operations 602-608. These updated speed limit values for the carriageway links can be used in later iterations to attribute default/saved speed limit values to path links not having speed limit values attributed/propagated to them via operations 602-604.

In certain instances, examples may perform an operation (not depicted) to use the updated digital map resulting from operations 602-608 as an input to an autonomous driving system (e.g., an AV system or an SAV system).

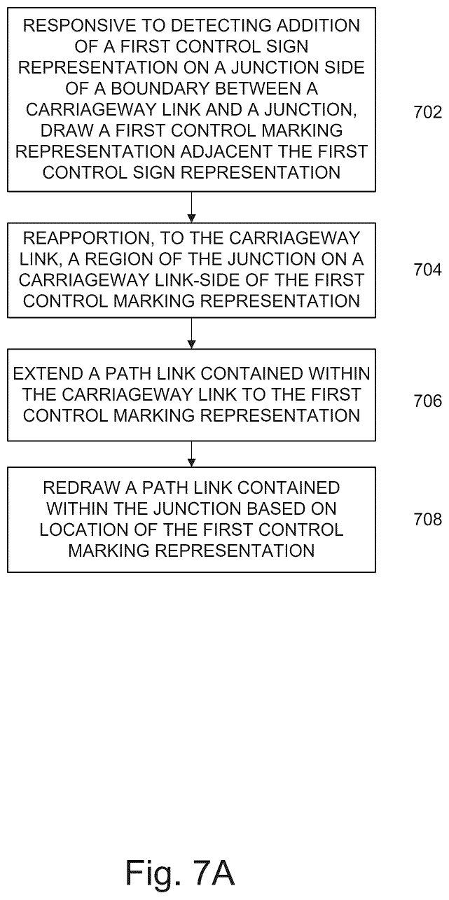

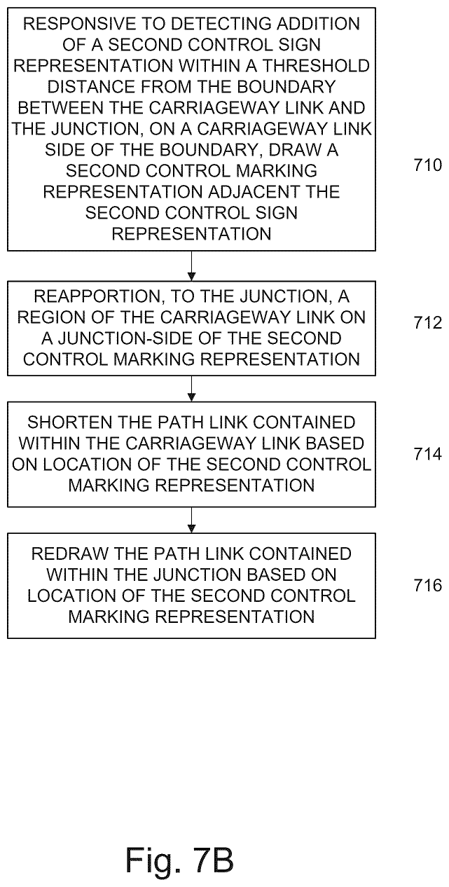

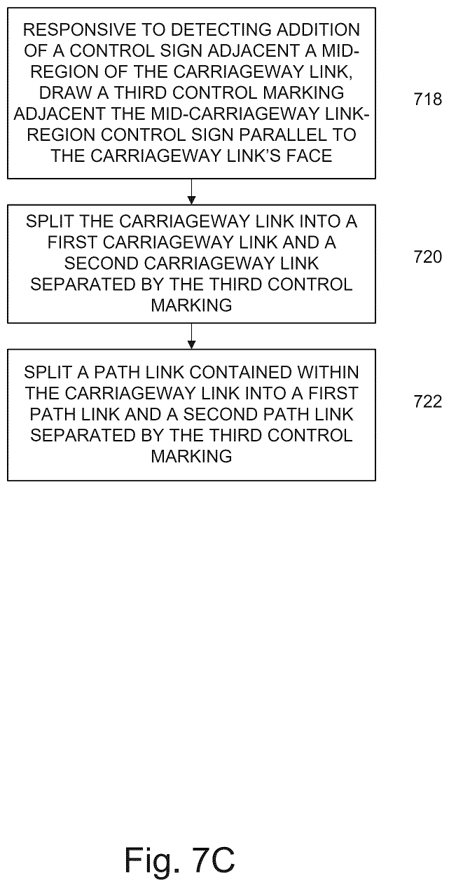

FIGS. 7A-7C are flowcharts illustrating example operations that can be performed to update a digital map in response to a control sign update, in accordance with various examples of the presently disclosed technology. In various examples the operations of FIGS. 7A-7C may be performed by digital map update circuit 110 of FIG. 1

As depicted in FIG. 7A, responsive to detecting addition of a first control sign representation on a junction side of a boundary between a carriageway link and a junction of the digital map, examples can perform operation 702 to draw a control marking representation adjacent the first control sign representation.

As described above, the digital map may comprise: (1) control sign representations representing control signs of the road network region; (2) carriageway links representing road segments of the road network region (in certain examples the carriageway links may represent polygons that enclose road segments of the road network region having a constant number of lanes); (3) junctions representing regions of intersection between road segments of the road network region; and (4) path links representing vehicular travel paths through lanes contained within the carriageway links and junctions. In various examples, the digital map may be a multi-layered digital map comprising: (a) a traffic sign layer comprising data related to traffic signs including the control sign representations; (b) a carriageway link layer comprising the carriageway links; (c) a junction layer comprising the junctions; and (d) a path link layer comprising the path links. As alluded to above, these multiple logical/hierarchical layers of the digital map are especially amenable to the rapid updates disclosed herein.

Examples can perform operation 704 to reapportion, to the carriageway link, a region of the junction on a carriageway link-side of the first control marking representation. Examples can then perform operation 706 to extend a path link contained within the carriageway link to the first control marking representation. Relatedly, examples can perform operation 708 to redraw a path link contained within the junction based on location of the first control marking representation.

Referring now to FIG. 7B, responsive to detecting addition of a second control sign representation within a threshold distance from the boundary between the carriageway link and the junction, on a carriageway link side of the boundary, examples can perform operation 710 to draw a second control marking representation adjacent the second control sign representation. Examples can then perform operation 712 to reapportion, to the junction, a region of the carriageway link on a junction-side of the second control marking representation. Relatedly, examples can perform operation 714 to shorten the path link contained within the carriageway link based on location of the second control marking representation. Likewise, examples can perform operation 716 to redraw the path link contained within the junction based on location of the second control marking representation.

Referring now to FIG. 7C, responsive to detecting addition of a third control sign representation adjacent the carriageway link and outside the threshold distance from a boundary between the carriageway link and any junction, examples can perform operation 718 to draw a third control marking representation adjacent the third control sign representation. Examples can then perform operation 720 to split the carriageway link into a second carriageway link and a third carriageway link separated by the third control marking representation. Relatedly, examples can perform operation 722 to split the path link contained within the carriageway link into a second path link and a third path link separated by the third control marking representation.

It should be understood that depending on scenario, examples may only perform the operations of only one of FIGS. 7A-7C for a given control sign update.

As alluded to above, examples may perform another operation (not depicted) to use the updated digital map as an input to an autonomous driving system (e.g., an AV system or an SAV system).

With respect to path link redrawing, various redrawing approaches can be used for different maneuver types (e.g., straight maneuvers, left turns, right turns, U-turns, etc.). For example, path links involving turn-related maneuvers may be redrawn to commence immediately at the beginning of (redrawn) junctions containing the path links involving the turn-related maneuvers. Special attention may be given to path links involving left turns because they can overlap with carriageway links jutting into a junction. Path links involving U-turns can be redrawn to be approximately semi-circular. If the origin and destination of the U-turn path link's boundaries are less than 1 m apart, a more ‘bulbous’ shape may be redrawn instead of a semi-circle.

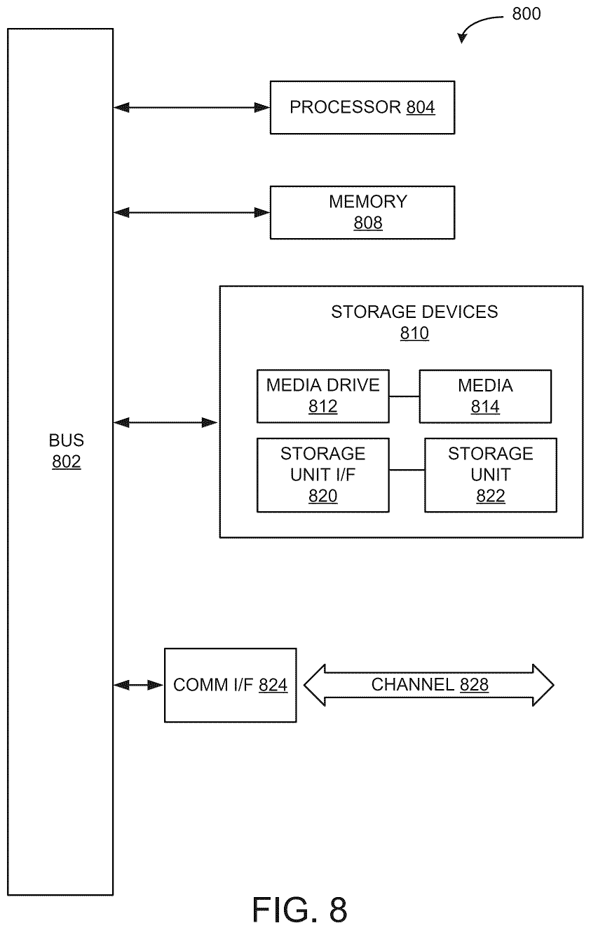

As used herein, the terms circuit and component might describe a given unit of functionality that can be performed in accordance with one or more examples of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 8. Various examples are described in terms of this example-computing component 800. After reading this description, it will become apparent to a person skilled in the relevant art how to implement the application using other computing components or architectures.

Referring now to FIG. 8, computing component 800 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 800 might also represent computing capabilities embedded within or otherwise available to a given device. For example, a computing component might be found in other electronic devices such as, for example, portable computing devices, and other electronic devices that might include some form of processing capability.

Computing component 800 might include, for example, one or more processors, controllers, control components, or other processing devices. Processor 804 might be implemented using a general-purpose or special-purpose processing engine such as, for example, a microprocessor, controller, or other control logic. Processor 804 may be connected to a bus 802. However, any communication medium can be used to facilitate interaction with other components of computing component 800 or to communicate externally.

Computing component 800 might also include one or more memory components, simply referred to herein as main memory 808. For example, random access memory (RAM) or other dynamic memory, might be used for storing information and instructions to be executed by processor 804. Main memory 808 might also be used for storing temporary variables or other intermediate information during execution of instructions to be executed by processor 804. Computing component 800 might likewise include a read only memory (“ROM”) or other static storage device coupled to bus 802 for storing static information and instructions for processor 804.

The computing component 800 might also include one or more various forms of information storage mechanism 810, which might include, for example, a media drive 812 and a storage unit interface 820. The media drive 812 might include a drive or other mechanism to support fixed or removable storage media 814. For example, a hard disk drive, a solid-state drive, a magnetic tape drive, an optical drive, a compact disc (CD) or digital video disc (DVD) drive (R or RW), or other removable or fixed media drive might be provided. Storage media 814 might include, for example, a hard disk, an integrated circuit assembly, magnetic tape, cartridge, optical disk, a CD or DVD. Storage media 814 may be any other fixed or removable medium that is read by, written to or accessed by media drive 812. As these examples illustrate, the storage media 814 can include a computer usable storage medium having stored therein computer software or data.

In alternative examples, information storage mechanism 810 might include other similar instrumentalities for allowing computer programs or other instructions or data to be loaded into computing component 800. Such instrumentalities might include, for example, a fixed or removable storage unit 822 and an interface 820. Examples of such storage units 822 and interfaces 820 can include a program cartridge and cartridge interface, a removable memory (for example, a flash memory or other removable memory component) and memory slot. Other examples may include a PCMCIA slot and card, and other fixed or removable storage units 822 and interfaces 820 that allow software and data to be transferred from storage unit 822 to computing component 800.

Computing component 800 might also include a communications interface 824. Communications interface 824 might be used to allow software and data to be transferred between computing component 800 and external devices. Examples of communications interface 824 might include a modem or softmodem, a network interface (such as Ethernet, network interface card, IEEE 802.XX or other interfaces). Other examples include a communications port (such as for example, a USB port, IR port, RS232 port Bluetooth® interface, or other ports), or other communication interfaces. Software/data transferred via communications interface 824 may be carried on signals, which can be electronic, electromagnetic (which includes optical) or other signals capable of being exchanged by a given communications interface 824. These signals might be provided to communications interface 824 via a channel 828. Channel 828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 808, storage unit 820, media 814, and channel 828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 800 to perform features or functions of the present application as discussed herein.

It should be understood that the various features, aspects and functionality described in one or more of the individual examples are not limited in their applicability to the particular example with which they are described. Instead, they can be applied, alone or in various combinations, to one or more other examples, whether or not such examples are described and whether or not such features are presented as being a part of a described example. Thus, the breadth and scope of the present application should not be limited by any of the above-described exemplary examples.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various examples set forth herein are described in terms of exemplary block diagrams, flow charts and other illustrations. As will become apparent to one of ordinary skill in the art after reading this document, the illustrated examples and their various alternatives can be implemented without confinement to the illustrated examples. For example, block diagrams and their accompanying description should not be construed as mandating a particular architecture or configuration.

What is claimed is:

1. A computer-implemented method comprising:
(a) responsive to detecting a speed limit sign update in a road network region, attributing, to path links of a digital map adjacent a speed limit sign representation, a speed limit value in accordance with the speed limit sign representation, wherein the attributions of step (a) reflect the detected speed limit sign update; and
(b) propagating, in a direction of travel indicated by path links, the attributed speed limit values from step (a) to path links non-adjacent to speed limit sign representations, wherein the propagations of step (b) terminate at path links involving turn-related maneuvers.

2. The computer-implemented method of claim 1, further comprising:
(c) attributing, to path links contained within carriageway links and without speed limit values attributed or propagated to them via steps (a)-(b), previously saved speed limit values for their associated carriageway links; and
(d) propagating, in the direction of travel indicated by path links, the attributed and propagated speed limit values from steps (a)-(c) to the path links involving turn-related maneuvers.

3. The computer-implemented method of claim 2, further comprising:
(e) updating speed limit values for carriageway links based on the speed limit values attributed and propagated to path links from steps (b)-(d).

4. The computer-implemented method of claim 2, further comprising:
(e) using the updated digital map resulting from steps (a)-(d) as an input to an autonomous driving system.

5. The computer-implemented method of claim 1, wherein:
each of the path links includes a function type; and
the propagations of step (b) also terminate at transitions between path links of differing function types.

6. The computer-implemented method of claim 1, wherein the digital map comprises:
speed limit sign representations representing speed limit signs of the road network region;
carriageway links representing road segments of the road network region;
junctions representing regions of intersection between road segments of the road network region; and
path links representing vehicular travel paths through lanes contained within the carriageway links and junctions.

7. The computer-implemented method of claim 6, wherein the carriageway links represent polygons that enclose road segments of the road network region having a constant number of lanes.

8. The computer-implemented method of claim 6, wherein the digital map comprises:
a traffic sign layer comprising data related to traffic signs including the speed limit sign representations;
a carriageway link layer comprising the carriageway links;
a junction layer comprising the junctions; and
a path link layer comprising the path links.

9. A computer-implemented method for updating a digital map of a road network region, the method comprising, responsive to detecting addition of a control sign representation on a junction side of a boundary between a carriageway link and a junction of the digital map:
drawing a control marking representation adjacent the control sign representation;
reapportioning, to the carriageway link, a region of the junction on a carriageway link-side of the control marking representation;
extending a path link contained within the carriageway link to the control marking representation; and
redrawing a path link contained within the junction based on location of the control marking representation.

10. The computer-implemented method of claim 9, further comprising, responsive to detecting addition of a second control sign representation within a threshold distance from the boundary between the carriageway link and the junction, on a carriageway link side of the boundary:
drawing a second control marking representation adjacent the second control sign representation;
reapportioning, to the junction, a region of the carriageway link on a junction-side of the second control marking representation;
shortening the path link contained within the carriageway link based on location of the second control marking representation; and
redrawing the path link contained within the junction based on location of the second control marking representation.

11. The computer-implemented method of claim 9, further comprising, responsive to detecting addition of a third control sign representation adjacent the carriageway link and outside a threshold distance from a boundary between the carriageway link and any junction:
drawing a third control marking representation adjacent the third control sign representation;
splitting the carriageway link into a second carriageway link and a third carriageway link separated by the third control marking representation; and
splitting the path link contained within the carriageway link into a second path link and a third path link separated by the third control marking representation.

12. The computer-implemented method of claim 9, further comprising:
using the updated digital map as an input to an autonomous driving system.

13. The computer-implemented method of claim 9, wherein the digital map comprises:
control sign representations representing control signs of the road network region;
carriageway links representing road segments of the road network region;
junctions representing regions of intersection between road segments of the road network region; and
path links representing vehicular travel paths through lanes contained within the carriageway links and junctions.

14. The computer-implemented method of claim 13, wherein the carriageway links represent polygons that enclose road segments of the road network region having a constant number of lanes.

15. The computer-implemented method of claim 13, wherein the digital map comprises:
a traffic sign layer comprising data related to traffic signs including the control sign representations;
a carriageway link layer comprising the carriageway links;
a junction layer comprising the junctions; and
a path link layer comprising the path links.

16. A vehicle comprising:
an ECU including machine executable instructions in non-transitory memory to perform a method comprising, responsive to detecting addition of a control sign representation within a threshold distance from a boundary between a carriageway link and a junction of a digital map, on a carriageway link side of the boundary:
drawing a control marking representation adjacent the control sign representation,
reapportioning, to the junction, a region of the carriageway link on a junction-side of the control marking representation,
shortening a path link contained within the carriageway link based on location of the control marking representation, and
redrawing a path link contained within the junction based on location of the control marking representation.

17. The vehicle of claim 16, wherein the method further comprises, responsive to detecting addition of a second control sign representation on a junction side of the boundary between the carriageway link and the junction:
drawing a second control marking representation adjacent the second control sign representation;
reapportioning, to the carriageway link, a region of the junction on a carriageway link-side of the second control marking representation,
extending the path link contained within the carriageway link to the second control marking representation, and
redrawing the path link contained within the junction based on location of the second control marking representation.

18. The vehicle of claim 16, wherein the method further comprises, responsive to detecting addition of a third control sign representation adjacent the carriageway link and outside the threshold distance from a boundary between the carriageway link and any junction:
drawing a third control marking representation adjacent the third control sign representation;
splitting the carriageway link into a second carriageway link and a third carriageway link separated by the third control marking representation; and
splitting the path link contained within the carriageway link into a second path link and a third path link separated by the third control marking representation.

19. The vehicle of claim 16, further comprising:
an autonomous driving system;
wherein the method further comprises using the updated digital map as an input to the autonomous driving system.

20. The vehicle of claim 16, wherein the digital map comprises:
control sign representations representing control signs of a road network region;
carriageway links representing road segments of the road network region;
junctions representing regions of intersection between road segments of the road network region; and
path links representing vehicular travel paths through lanes contained within the carriageway links and junctions.
